(19) United States
(12) Patent Application Publication
(10) Pub. No.: US 2009/0090210 A1
(43) Pub. Date: Apr. 9, 2009

(54) COLLAPSIBLE STEERING COLUMN ASSEMBLY

(75) Inventors: Damir Menjak, Frankenmuth, MI (US); Ratko Menjak, Frankenmuth, MI (US)

Correspondence Address: HOWARD & HOWARD ATTORNEYS PLLC, 450 West Fourth Street, Royal Oak, MI, 48067, US

(73) Assignee: DELPHI TECHNOLOGIES, INC., Troy, MI (US)

(21) Appl. No.: 12/236,988

(22) Filed: Sep. 24, 2008

Related U.S. Application Data
(60) Provisional application No. 60/977,822, filed on Oct. 5, 2007.

(51) Int. Cl. B62D 1/18

(52) U.S. Cl. 74/492

(57) ABSTRACT

A steering column assembly includes a column jacket longitudinally collapsible along a longitudinal axis. A release module is releasably coupled to the column jacket and attaches the column jacket to the vehicle at a connection point laterally offset from a first position along the longitudinal axis. An energy absorption system includes a strap attached to the column jacket at an attachment point latterly offset from a second position along the longitudinal axis and a deformation device disposed on the release module. The deformation device is laterally offset from a third position along the longitudinal axis disposed between the first position and the second position.

### CROSS REFERENCE TO RELATED APPLICATION

This application claims the benefit of U.S. Provisional Patent Application Ser. No. 60/977,822, filed on Oct. 5, 2007, the disclosure of which is hereby incorporated by reference.

### BACKGROUND OF THE INVENTION

1. Field of the Invention

The subject invention generally relates to a steering column assembly for a vehicle, and more specifically to a collapsible steering column assembly having an energy absorption system for absorbing energy during collapse of the steering column assembly.

2. Description of the Prior Art

Vehicle steering column assemblies are typically equipped with a kinetic energy absorption system. The energy absorption system reduces the likelihood or severity of an operator of the vehicle from being injured in the event of a collision that may cause the operator to impact a steering wheel attached to the steering column assembly. Such impacts during vehicle collisions typically cause the steering column assembly to collapse, thereby absorbing some of the energy that my otherwise be transmitted to the operator.

Such collapsible steering column assemblies generally include a housing that translates linearly through a collapse stroke during the collision. A force generated by the driver impacting the steering wheel initiates the collapse stroke. The steering wheel housing moves against a resisting or reactive force that is produced by the energy absorption system, which is designed to convert a portion of the driver's kinetic energy into work. The resisting force is typically generated by plastically deforming a metal element.

Typically, the collapsible steering column assembly includes a column jacket having an output end and a steering wheel attachment end. A bracket is mounted to the column jacket for attaching the column jacket to the vehicle. At least one, but preferably a pair of release modules releasably interconnects the bracket to the vehicle. The release modules may include a single bore, through which a fastener, such as a bolt, passes through to fixedly connect the release module to the vehicle. The energy absorption system typically includes a metal strap connected to the bracket for movement with the bracket and the column jacket during the collapse stroke. The strap passes through a deformation device, which includes a channel defining an anvil about which the strap is deformed. Often, the deformation channel is incorporated into the release module.

Traditionally, the channel has been disposed opposite the release module fastener from the point of attachment where the strap is connected to the bracket. Accordingly, if the fastener connecting the release module to the vehicle is not properly tightened or slips, as the column jacket moves along the longitudinal axis during collapse, the strap will pull on the channel and cause the channel to rotate about the release module fastener, thereby preventing the energy absorption system from functioning properly.

### SUMMARY OF THE INVENTION AND ADVANTAGES

The subject invention provides a steering column assembly for a vehicle. The steering column assembly comprises a column jacket. The column jacket is longitudinally collapsible along a longitudinal axis in response to a collision event. A release module is releasably coupled to the column jacket. The release module includes a connection point for connecting the release module to the vehicle. The release module is coupled to the column jacket prior to the longitudinal collapse of the column jacket, and is releasable from the column jacket in response to the longitudinal collapse of the column jacket. An energy absorption system includes a deformation device disposed on the release module and a strap. The strap includes an attachment point for attaching the strap to the column jacket. The strap extends through the deformation device such that the strap is drawn through and deformed by the deformation device in response to the longitudinal collapse of the column jacket to absorb energy. The attachment point is laterally offset from a first position along the longitudinal axis. The connection point is laterally offset from a second position along the longitudinal axis. The second position is spaced from the first position along the longitudinal axis. The deformation channel is laterally offset from a third position along the longitudinal axis. The third position is disposed between the first position and the second position.

Accordingly, the steering column assembly of the subject invention positions the channel of the energy absorption system between the attachment point of the strap to the column jacket and the connection point of the release module to the vehicle. Therefore, during collapse of the column jacket, the strap is drawn through the channel and pulls against the connection point of the release module. Thus, even if the release module is not properly tightened to the vehicle, i.e., is loose, the release module will not rotate about the connection point as the strap is drawn through the channel, thereby ensuring proper functioning of the energy absorption system.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a top plan view of a collapsible steering column assembly;

FIG. 2 is an enlarged fragmentary top plan view of the collapsible steering column assembly;

FIG. 3 is a fragmentary perspective view of the steering column assembly prior to collapse;

FIG. 4 is a fragmentary perspective view of the steering column assembly post collapse; and

FIG. 5 is a partial lower plan view of the steering column assembly showing two release modules coupled to a bracket.

### DETAILED DESCRIPTION OF THE INVENTION

Referring to the Figures, wherein like numerals indicate corresponding parts throughout the several views, a steering column assembly is shown generally at 20. The steering column assembly 20 is for a vehicle, and is collapsable in response to a collision event.

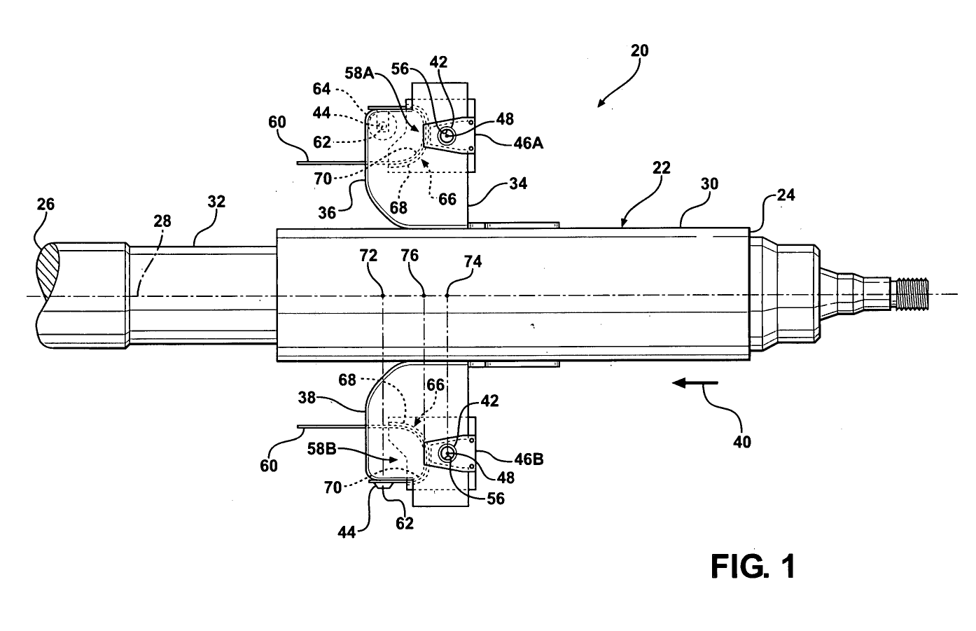

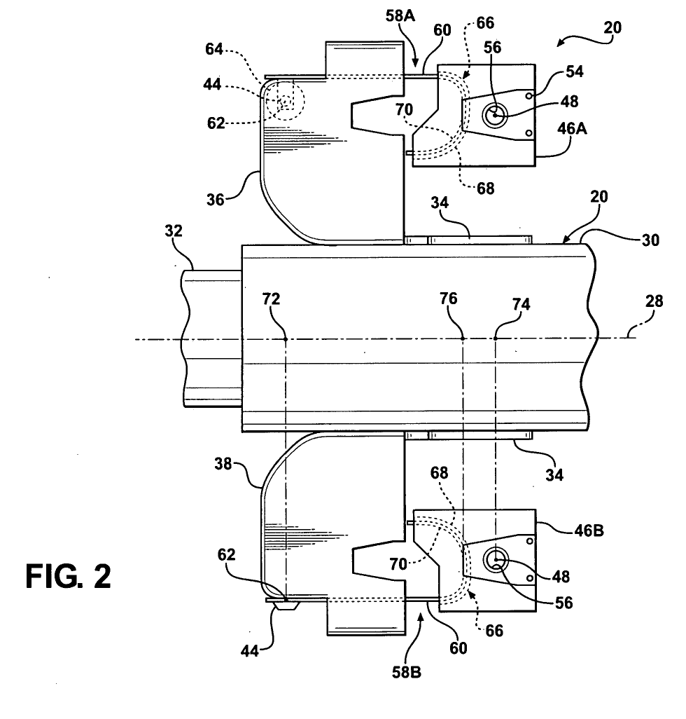

Referring to FIGS. 1 and 2, a steering column assembly 20 exemplifying the present invention is shown. The steering column assembly 20 includes a column jacket 22. The column jacket 22 includes an input end 24 and an output end 26. A steering shaft (not shown) is rotatably disposed within the column jacket 22. A steering wheel (not shown) is connected to the steering shaft near the input end 24 of the column jacket 22 as is well known in the art. The column jacket 22 and the steering shaft extend along a longitudinal axis 28. The steering shaft is located radially inward from and generally concentric with the column jacket 22. The column jacket 22 has a radially outward or upper jacket 30, and a radially inward or lower jacket 32.

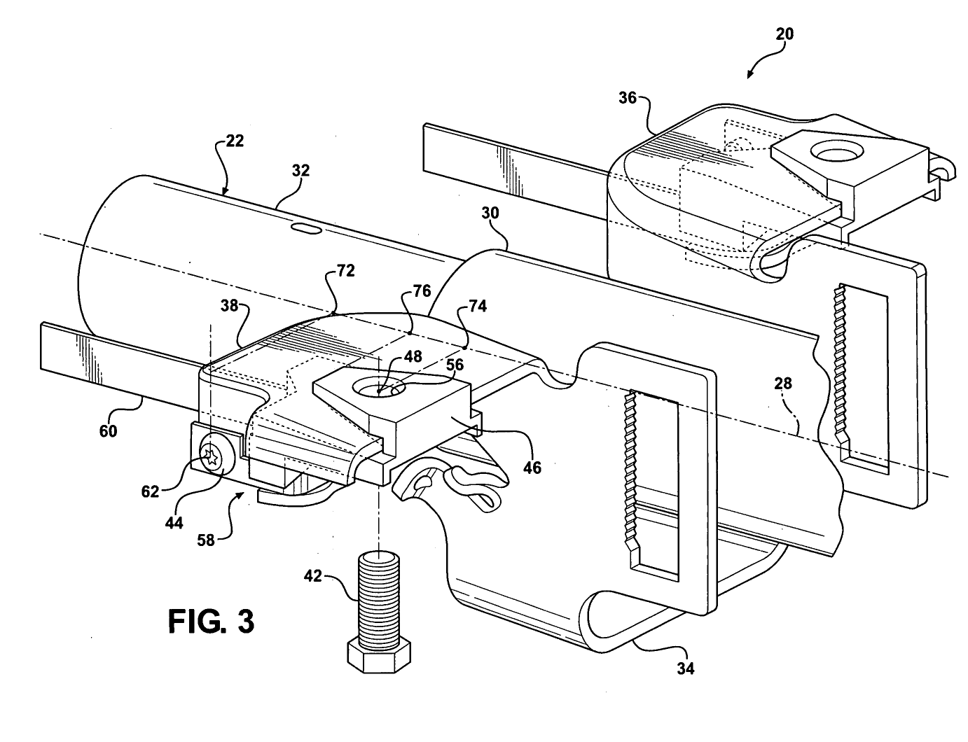

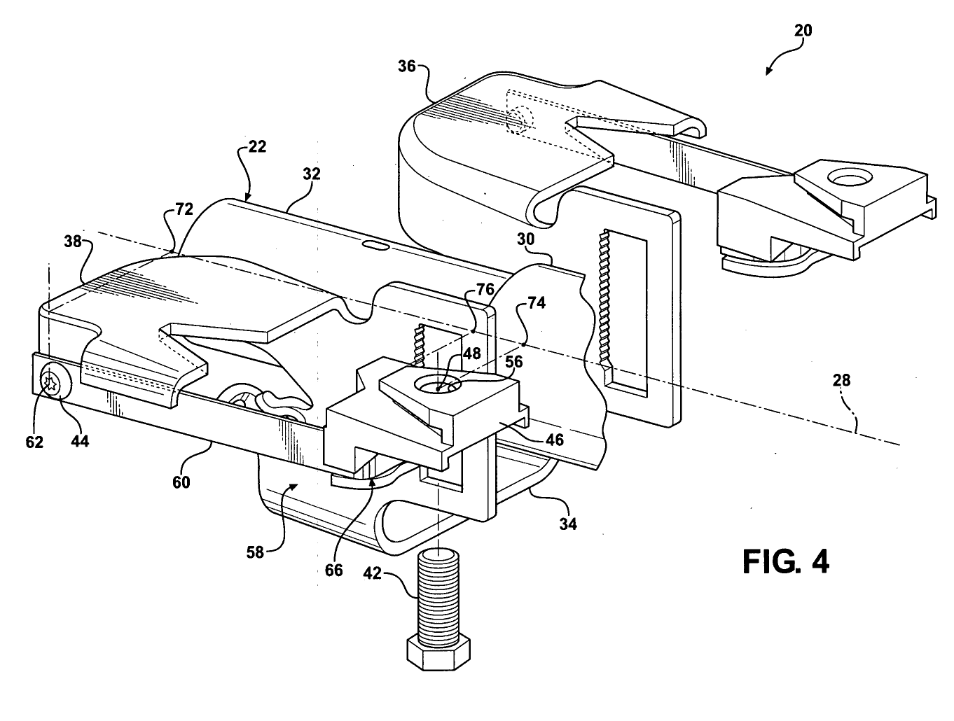

As shown with reference to FIG. 2, the steering column assembly 20 collapses along the longitudinal axis 28 toward the output end 26 of the column jacket 22 in response to a force applied to the steering wheel, i.e., an operator of the vehicle applies the force to the steering wheel and pushes the column jacket 22 along the longitudinal axis 28 toward the output end 26 of the column jacket 22. FIGS. 1 and 3 show the steering column assembly 20 prior to collapse, while FIGS. 2 and 4 show the steering column assembly 20 after collapse of the steering column assembly 20. It should be appreciated that the collision event is typically a vehicular crash, in which an operator of the vehicle transmits a force to the steering wheel and thereby to the steering column assembly 20.

Referring back to FIG. 1, with reference to FIG. 2, the column jacket 22 includes a bracket 34. The bracket 34 is fixedly attached to the column jacket 22. Specifically, the bracket 34 is attached to the upper jacket 30 and moveable with the upper jacket 30 along the longitudinal axis 28 during the collapse stroke. The bracket 34 preferably includes a first extension 36 and a second extension 38 extending outwardly from opposing sides of the column jacket 22. The column jacket 22 and the bracket 34 are moveable along the longitudinal axis 28 in response to the collision event in a direction indicated by arrow 40. The bracket 34 may be connected by welding, fasteners 42, 44, may be integrally formed with the column jacket 22, or may be connected to the column jacket 22 in some other suitable manner.

A release module 46 is releasably coupled to the column jacket 22. Specifically, the release module 46 is coupled to the bracket 34. The release module 46 includes a connection point 48 for connecting the release module 46 to the vehicle. The release module 46 is coupled to the column jacket 22 prior to the longitudinal collapse of the column jacket 22, and is releasable from the column jacket 22 in response to the longitudinal collapse of the column jacket 22. The release module 46 couples the bracket 34 and thereby the column jacket 22 to the vehicle prior to the collision event, and releases the bracket 34 and thereby the column jacket 22 from the vehicle in response to movement of the bracket 34 and the column jacket 22 along the longitudinal axis 28.

The release module 46 is fixedly attached to the vehicle, and stays connected to the vehicle after the bracket 34 and the column jacket 22 are released from the release module 46. Typically, the release module 46 includes a first portion fixedly coupled to the column jacket 22 and a second portion fixedly attached to the vehicle and releasably couple to the first portion of the release module 46. The release module 46 includes a plurality of sheer pins 54 interconnecting the first portion of the release module 46 and the second portion of the release module 46. The shear pins are shearable, i.e., fracture, when the column jacket 22 collapses forward along the longitudinal axis 28, thereby disconnecting the first portion and the bracket 34 from the second portion and the vehicle. However, it should be appreciated that the release module 46 may be coupled to the bracket 34 or the column jacket 22 in some other suitable fashion. The release module 46 may include a first release module 46A releasably coupled to the first extension 36 and a second release module 46B releasably coupled to the second extension 38.

The release module 46 includes a bore 56 extending therethrough and concentric with the connection point 48. A release module fastener 42 extends through the bore 56 for fixedly attaching the release module 46 to the vehicle. The release module fastener 42 may include a bolt, a screw or some other suitable fastening device.

The steering column assembly 20 further includes an energy absorption system 58. The energy absorption system 58 interconnects the bracket 34 and thereby the column jacket 22 to the release module 46 and thereby to the vehicle. The energy absorption system 58 includes a strap 60. The strap 60 includes an attachment point 62 for attaching the strap 60 to the column jacket 22. Preferably, the strap 60 is coupled to the bracket 34. The strap 60 is plastically deformable, and is preferably a metal. However, it should be appreciated that the strap 60 may include some other plastically deformable material. The strap 60 is coupled to the bracket 34. The strap 60 may be fixedly connected to the bracket 34. Preferably, the strap 60 is secured to the column jacket 22, i.e., the bracket 34, by a strap fastener 44. The strap fastener 44 may include a screw, bolt, or some other similar fastener. However, it should be appreciated that other devices may be utilized to fixedly connect the strap 60 to the bracket 34. The strap fastener 44 is concentric with the attachment point 62.

Alternatively, the strap 60 may be selectively coupled to the bracket 34. Selectively coupling the strap 60 to the bracket 34 allows for a two stage energy absorption system 58, in which a first stage permits collapse of the column jacket 22 without resistance provided by the energy absorption system 58 by not connecting the strap 60 to the bracket 34, and a second stage in which the energy absorption system 58 does provide resistance against movement of the column jacket 22 by connecting the strap 60 to the bracket 34. An actuator 64 is attached to the bracket 34 in order to selectively couple the strap 60 to the bracket 34. A controller (not shown) signals the actuator 64 to couple the strap 60 to the bracket 34 if desired. The actuator 64, if signaled, may move the strap fastener 44, such as a pin, through an aperture in the strap 60 to connect the strap 60 to the bracket 34. The actuator 64 may include a pyrotechnic device or some other suitable device. However, it should be appreciated that the strap 60 may be selectively coupled to the bracket 34 by some other manner not shown or described herein.

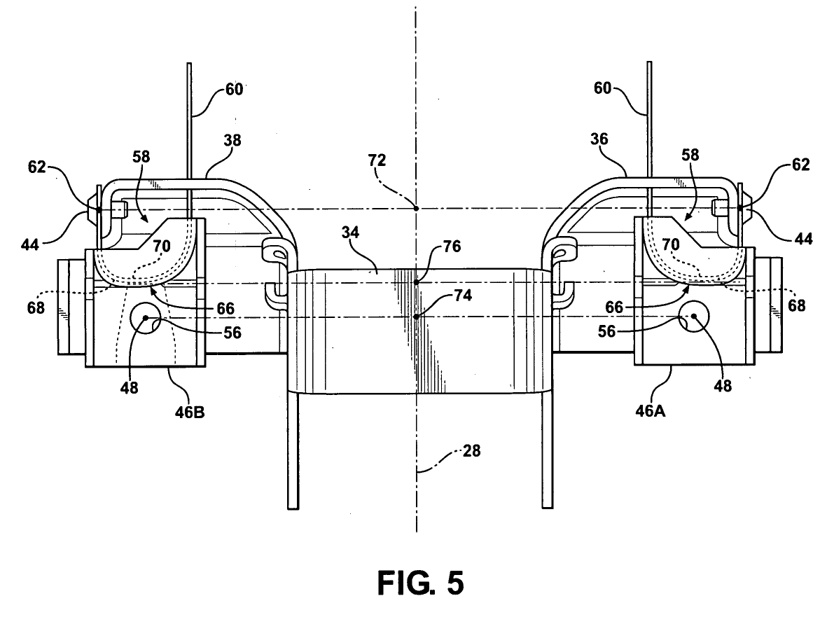

As best shown in FIG. 5, the energy absorption system 58 further includes a deformation device 66. The deformation device 66 includes a channel 68 defining an anvil 70. The channel 68 and therefore the anvil 70 are disposed on the release module 46. Preferably, but not necessarily, the channel 68 and the anvil 70 are integrally formed with the second portion of the release module 46. The strap 60 is disposed within and extends through the channel 68. The strap 60 is drawn through and deformed by the channel 68 in response to movement of the column jacket 22 in response to the longitudinal collapse of the column jacket 22 along the longitudinal axis 28. FIGS. 1, 3 and 5 show the strap 60 prior to being drawn through the channel 68. FIGS. 2 and 4 show the strap 60 after the strap 60 has been drawn through the channel 68.

As described above, the channel 68 defines and includes the anvil 70, about which the strap 60 is deformed as the strap 60 is drawn through the channel 68. The anvil 70 is disposed on the release module 46. The channel 68 and the anvil 70 may include any suitable shape. As shown, the channel 68 and the anvil 70 generally define a U-shape. However, it should be appreciated that the resistance provided by the energy absorption system 58 is determined by the amount of energy required to deform the strap 60 as the strap 60 is drawn through the channel 68. Accordingly, a more complex channel 68 having more and/or smaller radius bends, increases the amount of energy required to deform the strap 60 and thereby increases the resistance provided against movement of the column jacket 22.

The attachment point 62 of the strap 60 is laterally offset from a first position 72 along the longitudinal axis 28. The connection point 48 of the release module 46 is laterally offset from a second position 74 along the longitudinal axis 28. The second position 74 is spaced from the first position 72 along the longitudinal axis 28. The deformation device 66, i.e., the channel 68 and the anvil 70, is laterally offset from a third position 76 along the longitudinal axis 28. The third position 76 is disposed between the first position 72 and the second position 74, i.e., between the attachment point 62 of the strap 60 and the connection point 48 of the release module 46.

Accordingly, the anvil 70 is also disposed between the attachment point 62 of the strap 60 and the connection point 48 of the release module 46, i.e., between the first position 72 and the second position 74. Accordingly, it should be appreciated that during the collapse stroke of the steering column assembly 20, as the column jacket 22 moves along the longitudinal axis 28 and draws the strap 60 through the channel 68, the channel 68 and the anvil 70 will not be able to rotate about the release module fastener 42 connecting the release module 46 to the vehicle, even if the release module fastener 42 is not properly tightened, thereby ensuring proper functioning of the energy absorption system 58.

Referring back to FIGS. 1 and 2, the steering column assembly 20 may include one or more energy absorption systems 58. If multiple energy absorption systems 58 are utilized then one or more of the energy absorption systems 58 may be selectively coupled to the bracket 34 as described above to provide multiple stages of resistance. The steering column assembly 20 includes a first energy absorption system 58A and a second energy absorption system 58B with the strap 60 of the first energy absorption system 58 fixedly connected to the bracket 34 and the strap 60 of the second energy absorption system 58 selectively coupled to the bracket 34. Accordingly, the first energy absorption system 58A will always be available to resist movement of the column jacket 22, while the second energy absorption system 58B may be selectively engaged if desired.

The invention has been described in an illustrative manner, and it is to be understood that the terminology which has been used is intended to be in the nature of words of description rather than of limitation. As is now apparent to those skilled in the art, many modifications and variations of the present invention are possible in light of the above teachings. It is, therefore, to be understood that within the scope of the appended claims, wherein reference numerals are merely for convenience and are not to be in any way limiting, the invention may be practiced otherwise than as specifically described.

What is claimed is:

1. A steering column assembly for a vehicle, said assembly comprising:
a column jacket longitudinally collapsible along a longitudinal axis in response to a collision event;
a release module releasably coupled to said column jacket and including a connection point for connecting said release module to the vehicle with said release module coupled to said column jacket prior to said longitudinal collapse of said column jacket and releasable from said column jacket in response to said longitudinal collapse of said column jacket;
an energy absorption system including a deformation device disposed on said release module and a strap having an attachment point for attaching said strap to said column jacket with said strap extending through said deformation device such that said strap is drawn through and deformed by said deformation device in response to said longitudinal collapse of said column jacket to absorb energy;
said attachment point being laterally offset from a first position along said longitudinal axis and said connection point being laterally offset from a second position spaced from said first position along said longitudinal axis with said deformation channel laterally offset from a third position along said longitudinal axis with said third position disposed between said first position and said second position.

2. An assembly as set forth in claim 1 wherein said deformation device includes a channel defining an anvil for deforming said strap as said strap is drawn through said channel.

3. An assembly as set forth in claim 2 wherein said anvil is disposed on said release module.

4. An assembly as set forth in claim 3 wherein said anvil is integrally formed with said release module.

5. An assembly as set forth in claim 3 wherein said release module includes a first portion fixedly coupled to said column jacket and a second portion attached to the vehicle and releasably coupled to said first portion with said anvil disposed on said second portion of said release module.

6. An assembly as set forth in claim 5 wherein said release module includes a plurality of shear pins interconnecting said first portion of said release module and said second portion of said release module with said plurality of shear pins shearable in response to said longitudinal collapse of said column jacket.

7. An assembly as set forth in claim 1 wherein said release module includes a bore concentric with said connection point.

8. An assembly as set forth in claim 7 further comprising a release module fastener extending through said bore for attaching said release module to the vehicle.

9. An assembly as set forth in claim 8 further comprising a strap fastener concentric with said attachment point for attaching said strap to said column jacket.

10. An assembly as set forth in claim 1 wherein said column jacket includes a bracket with said release module releasably coupled to said bracket of said column jacket.

11. An assembly as set forth in claim 10 wherein said bracket includes a first extension and a second extension extending outwardly from said column jacket on opposing sides of said column jacket.

12. An assembly as set forth in claim 11 wherein said release module includes a first release module releasably coupled to said first extension and a second release module releasably coupled to said second extension.

13. An assembly as set forth in claim 10 wherein said strap is coupled to said bracket.

14. An assembly as set forth in claim 11 wherein said energy absorption system includes a first energy absorption system and a second energy absorption system.

15. An assembly as set forth in claim 14 further comprising an actuator for moving said strap fastener of at least one of said first energy absorption system and said second energy absorption system into attaching engagement between said strap and said column jacket.

16. An assembly as set forth in claim 15 wherein said actuator includes a pyrotechnic device.

17. An assembly as set forth in claim 10 wherein said column jacket includes an upper jacket coupled to said bracket and a lower jacket telescopically engaged with said upper jacket with said upper jacket and said bracket moveable along said longitudinal axis during said longitudinal collapse.

18. An assembly as set forth in claim 1 wherein said strap is plastically deformable.

19. An assembly as set forth in claim 18 wherein said strap includes a metal.
